(19) United States
(12) Patent Application Publication
(10) Pub. No.: US 2009/0323488 A1
(43) Pub. Date: Dec. 31, 2009

(54) INFORMATION-PROCESSING APPARATUS, DEVICE, AND DEVICE SETTING CONTROL METHOD

(75) Inventors: Ken HATANO, Hamura-shi (JP); Tsuyoshi NISHIDA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/467,040

(22) Filed: May 15, 2009

(30) Foreign Application Priority Data
Jun. 30, 2008 (JP) 2008-170169

(51) Int. Cl. G11B 20/00; G06F 15/177

(52) U.S. Cl. 369/47.15; 713/1; G9B/20

(57) ABSTRACT

According to one embodiment, an information processing apparatus includes one or more devices, a device control module which performs drive control of the one or more devices, and a nonvolatile memory. Each of the one or more devices includes a command reception module which receives from the device control module a command to cause the nonvolatile memory to store operation setting information, a setting module which performs, when the operation setting information has been stored in the nonvolatile memory at the time of power-on or resetting, operation setting based on the information, and an erasing module which erases the information stored in the nonvolatile memory after the setting means has completed the operation setting. The device control module includes a command issuing module which issues to the one or more devices a command to cause the nonvolatile memory to store operation setting information before power-off or resetting.

### CROSS-REFERENCE TO RELATED APPLICATIONS

This application is based upon and claims the benefit of priority from Japanese Patent Application No. 2008-170169, filed Jun. 30, 2008, the entire contents of which are incorporated herein by reference.

### BACKGROUND

1. Field

One embodiment of the invention relates to device setting control technology suitable for a personal computer or the like provided with an optical disc drive which includes an operation setting function of limiting access to the inserted optical disc only for reading (or of inhibiting writing).

2. Description of the Related Art

In recent years, a variety of personal computers, including notebook computers and desktop computers, have been popularized. Since this type of computer is provided with various devices, including an HDD (hard disk drive) and an ODD (optical disc drive), as external storage apparatuses, the user can use various types of data on a single computer.

Recently, information leakage has been attracting attention as a social problem. In this connection, companies have taken measures to prevent important data from being taken out of the offices in the form of DVDs by setting the ODDs mounted on the personal computers so that ODDs can be read from but cannot be written into. Personal computers are lent to the employees for business purposes and can be connected to, for example, the in-house LAN (local area network).

A variety of methods of setting the operation of various devices mounted on a personal computer which are needed to take such measures have been proposed (e.g., Jpn. Pat. Appln. KOKAI Publication No. 7-182073).

The conventional methods, including the one disclosed in Jpn. Pat. Appln. KOKAI Publication No. 7-182073, are such that the BIOS (basic input/output system) issues a command to perform the desired operation setting to the target device at the time of power-on or resetting. This makes the start-up time of the personal computer longer by the time required to issue the command.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a system configuration of the information processing apparatus of the embodiment;

FIG. 3 is an exemplary view showing the schematically configuration of an ODD mounted on the information processing apparatus of the embodiment;

FIG. 4 is an exemplary flowchart showing the processing flow of device setting at the time of power-on or resetting in the information processing apparatus of the embodiment; and

FIG. 5 is an exemplary flowchart showing the processing flow of operating at the time of start-up, by turning on the power supply or by resetting, of each device mounted on the information processing apparatus of the embodiment.

### DETAILED DESCRIPTION

Various embodiments according to the invention will be described hereinafter with reference to the accompanying drawings. In general, according to one embodiment of the invention, an information processing apparatus includes one or more devices, a device control module which performs drive control of the one or more devices, and a nonvolatile memory. Each of the one or more devices includes a command reception module which receives from the device control module a command to cause the nonvolatile memory to store operation setting information, a setting module which performs, when the operation setting information has been stored in the nonvolatile memory at the time of power-on or resetting, operation setting based on the information, and an erasing module which erases the information stored in the nonvolatile memory after the setting means has completed the operation setting. The device control module includes a command issuing module which issues to the one or more devices a command to cause the nonvolatile memory to store operation setting information before power-off or resetting.

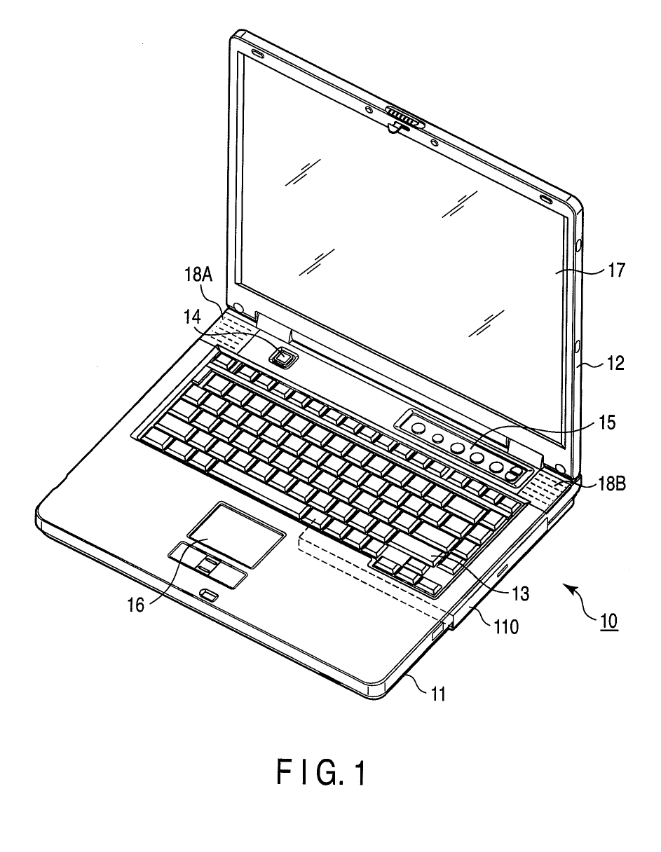

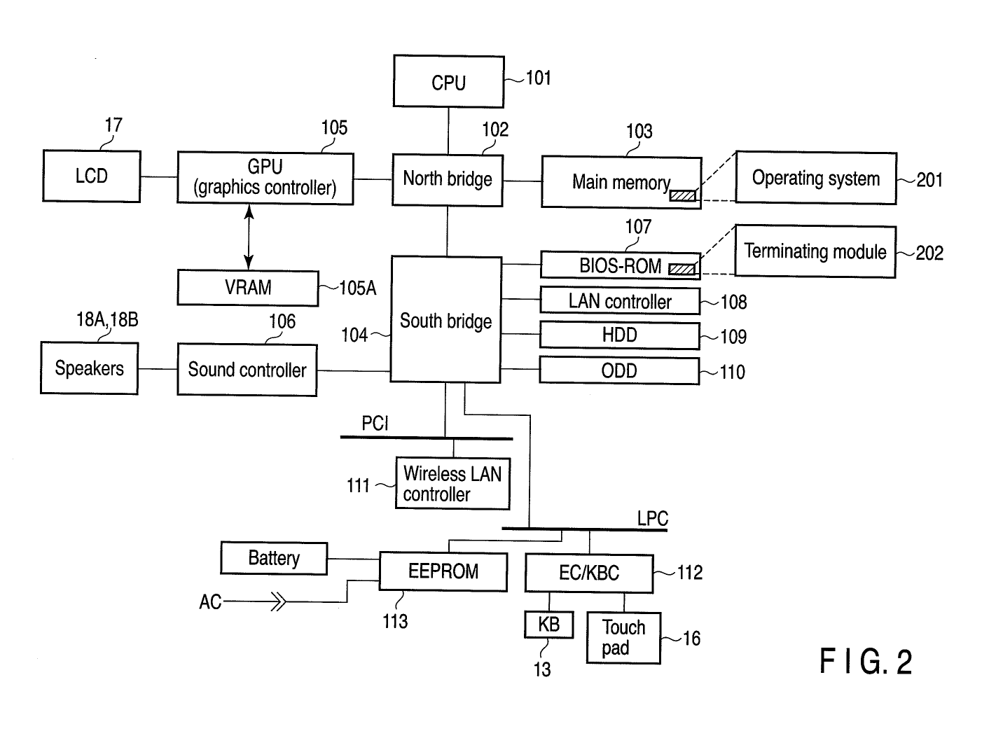

The configuration of an information processing apparatus according to an embodiment of the invention will be explained with reference to FIG. 1 and FIG. 2. The information processing apparatus of the embodiment is, for example, a notebook personal computer 10.

FIG. 1 is an exemplary perspective view of the personal computer 10, with the display unit opened. The computer 10 includes a computer body 11 and a display unit 12. A display device composed of an LCD (Liquid Crystal Display) 17 is incorporated into the display unit 12.

The display unit 12 is provided on the computer body 11 so as to be capable of rotation freely between the open position where the top surface of the computer body 11 is exposed and the closed position where the top surface of the computer body 11 is covered. The computer body 11 has a thin box-like chassis. On its top surface, there are provided a keyboard 13, a power button for powering on or off the computer 10, an input operation panel 15, a touch pad 16, speakers 18A, 18B. The input operation panel 15 is an input unit for inputting an event corresponding to the pressed button. The input operation panel 15 is provided with buttons for immediately activating a television (TV) function of viewing and recording broadcast program data transmitted using, for example, a TV broadcast signal, or a DVD function of reproducing video data recorded on a DVD.

In the right side of the computer body 11, a slot is made. The slot is for inserting or removing a optical disc into or from a optical disc drive (ODD) 110 provided in the computer body 11.

Next, the system configuration of the computer 10 will be explained with reference to FIG. 2.

As shown in FIG. 2, the computer 10 includes a CPU 101, a north bridge 102, a main memory 103, a south bridge 104, a graphics controller 105, a video memory (VRAM) 105A, a sound controller 106, a BIOS-ROM 107, a LAN controller 108, a hard disk drive (HDD) 109, an optical disc drive (ODD) 110, a wireless LAN controller 111, an embedded controller/keyboard controller (EC/KBC) 112, and a power controller 113.

The CPU 101, which is a processor which controls the operation of the computer 10, executes an operating system (OS) 201 and various application programs (including utilities) that operate under the control of the OS 201 loaded from the HDD 109 into the main memory 103. The CPU 101 also executes the BIOS stored in the BIOS-ROM 107. The BIOS is a program for hardware control. Hereinafter, the BIOS stored in the BIOS-ROM 107 is sometimes referred to as BIOS 107.

The north bridge 102 is a bridge device which connects a local bus of the CPU 101 and the south bridge 104. A memory controller for performing access control of the main memory 103 is incorporated into the north bridge 102. The north bridge 102 also includes the function of communicating with the graphics controller 105 via a serial bus complying with the PCI EXPRESS standard.

The graphics controller 105 is a display controller which controls the LCD 17 used as a display monitor of the computer 10. The display signal generated by the graphics controller 105 is sent to the LCD 17.

The south bridge 104 controls each device on a PCI (Peripheral Component Interconnect) bus and each device on an LPC (Low Pin Count) bus. The south bridge 104 includes an IDE (Integrated Drive Electronics) controller for controlling the HDD 109 and the ODD 110. The south bridge 104 also includes the function of communicating with the sound controller 106 and LAN controller 108.

The sound controller 106, which is a sound source device, outputs audio data to be reproduced to the speakers 18A, 18B. The LAN controller 108 is a wired communication device which performs wire communication complying with, for example, the Ethernet (a registered trademark) standard. The wireless LAN controller 111 is a wireless communication device which performs wireless communication complying with, for example, the IEEE 802.11 standard.

The EC/KBC 112 is a one-chip microcomputer into which an embedded controller for power management and a keyboard controller for controlling the keyboard (KB) 13 and touch pad 16 are housed. The EC/KBC 112, which is incorporation with the power controller 113, performs control to supply power from a battery or an AC adapter to various parts. That is, the EC/KBC 112 includes the function of powering on or off the computer 10 according to the user operation of the power button 14.

The ODD 110 mounted on the computer 10 configured as described above can be set so as to be capable of reading data only from the installed optical disc, that is, inhibiting data from being written onto the installed optical disc. This prevents data leakage due to taking out optical disc. Generally, the operation setting of the ODD 110 is realized by BIOS 107 issuing a command at the time of power-on or resetting. However, in this case, the start-up time is lengthened by the time required to issue a command. To overcome this problem, the computer 10 is provided with a mechanism for preventing the start-up time of the computer from being lengthened. Hereinafter, this will be explained in detail.

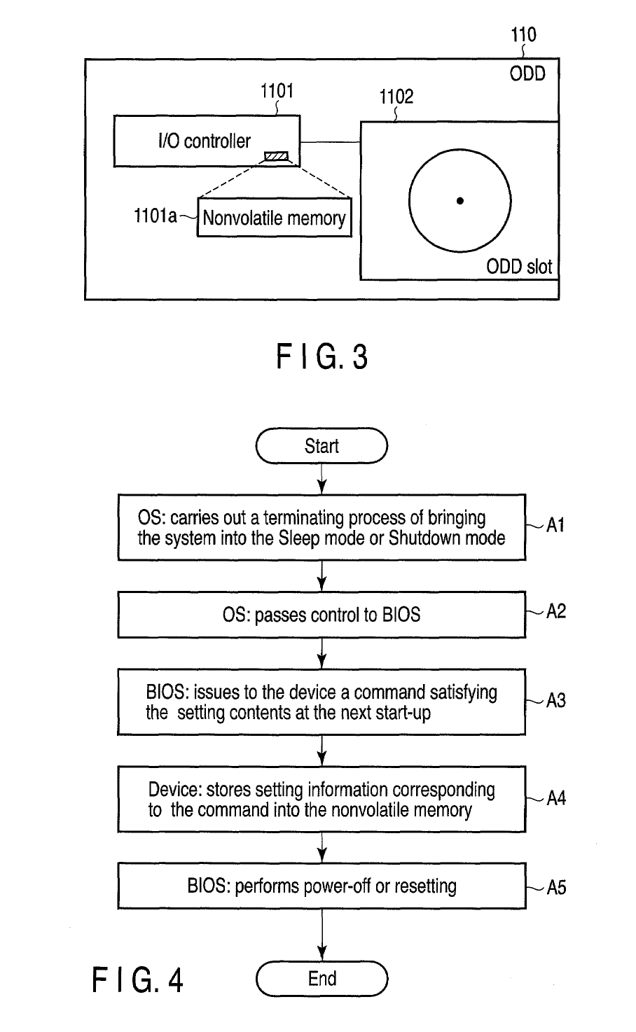

In the computer 10, the ODD 110, which includes a nonvolatile memory for storing operation setting information, includes the function of performing operation setting automatically on the basis of the operation setting information stored in the nonvolatile memory at the time of power-on or resetting and, after the operation setting, erasing the operation setting information stored in the nonvolatile memory. FIG. 3 shows a schematic configuration of the ODD 110 mounted on the computer 10.

As shown in FIG. 3, the ODD 110 includes an I/D controller 1101 and an ODD slot 1102. The I/o controller 1101, which is a host interface unit which supervises communication with the south bridge 104 side, accesses the magneto optical disc installed in the ODD slot 1102 and performs operation setting in response to various commands transmitted from the south bridge 104 side. Moreover, the I/O controller 1101, which includes a nonvolatile memory 1101a, stores the information into the nonvolatile memory 1101a when having received a command to store, for example, operation setting information for inhibiting data from being written onto an optical disc and, at the time of power-on or resetting, performs operation setting to inhibit data from being written onto the optical disc automatically on the basis of the information (without waiting for the transmission of the commend from the south bridge 104 side). After the operation setting, the I/O controller 1101 erases the information from the nonvolatile memory 1101a.

Moreover, the BIOS 107 includes a terminating module 202 which, before power-off or resetting, issues to the ODD 110 a command to store operation setting information for inhibiting data from being written onto the optical disc into the nonvolatile memory 1101a. Since the BIOS 107, at the time of power-off or resetting, receives control from the OS 201 that has completed the terminating process, the terminating module 202 issues the command to the ODD 110 at this time.

Specifically, in the computer 10, when control is passed to the BIOS 107 (or when the BIOS 107 secures control), for example, when the power supply is turned off, the BIOS 107 issues an operation setting command to the ODD 110. When the power supply is turned on, the ODD 110 performs operation setting automatically on the basis of the information in the nonvolatile memory 1101a, regardless of the issuance of the command. Consequently, the start-up time is prevented from being lengthened. Since the ODD 110 erases the information in the nonvolatile memory 1101a each time the operation setting is performed, the ODD 110, a device of the computer 10, performs operation setting under the control of the BIOS 107 as before.

While the nonvolatile memory 1101a for storing operation setting information is provided in the ODD 110, it may be provided in the body of the computer 10 and, at the time of power-on or resetting, the ODD 110 may read the operation setting information from the nonvolatile memory in the body and perform operation setting automatically and, after the operation setting, erase the operation setting information stored in the nonvolatile memory.

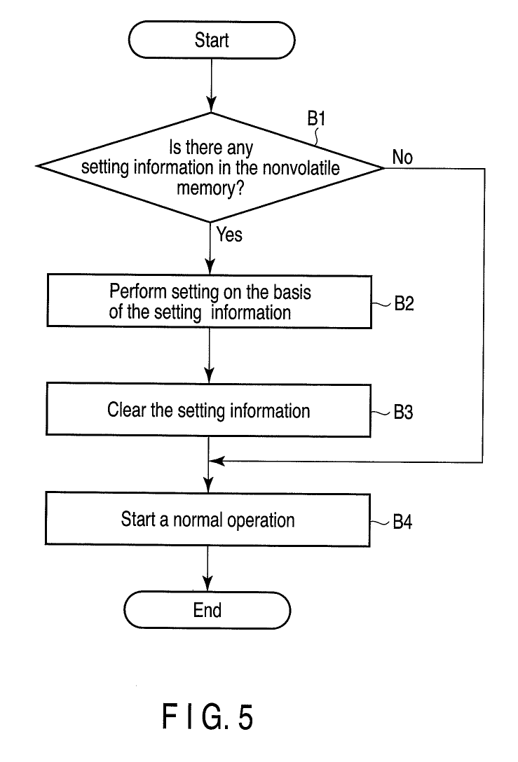

Next, the operation procedure for device setting in the computer 10 will be explained with reference to FIG. 4 and FIG. 5.

FIG. 4 is an exemplary flowchart showing the processing flow of device setting in the computer 10 at the time of power-on or resetting.

First, the OS 201 carries out a terminating process of bringing the system into a sleep mode or a shutdown mode (block A1) and, after the completion of the process, passes control to the BIOS 107 (block A2).

Having received control, the BIOS 107 issues a command to cause the device side to hold information indicating the contents of the operation setting to a device to be caused by the terminating module 202 to perform specific operation setting at the next start-up (block A3). Having received the command, the device stores the information into the nonvolatile memory (block A4). Then, when the terminating module 202 has completed issuing the command, the BIOS 107 turns off the power supply of the system or resets the system (block A5).

FIG. 5 is an exemplary flowchart to explain the processing flow in each device at the time of power-on or resetting.

Each device first checks whether there is any operating setting information in the nonvolatile memory (block B1). If there is operating setting information (YES in block B1), the device performs operation setting on the basis of the information (block B2). After having completed the operation setting, the device erases the information from the nonvolatile memory (block B3). After having erased the information, the device starts a normal operation (block B4). If there is no operation setting information (NO in block B1), the device starts a normal operation immediately (block B4).

As described above, the computer 10 prevents the start-up time from being lengthened.

While the BIOS 107 has issued a command to each device before power-off or resetting, the function corresponding to the terminating module 202 may be provided not only in the BIOS 107 but also in other various units, including a device driver included in the OS 201. The method of the invention is not limited to the ODD 110 and may be applied to various devices.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising;
at least one device;
a device controller configured to drive-control of the at least one device; and
a nonvolatile memory,
each of the at least one device comprising:
a command receiver configured to receive a command from the device controller which causes the nonvolatile memory to store operation setting information;
a setting module configured to register operation setting based on the information at the time of either power-on or resetting, if the operation setting information has been stored in the nonvolatile memory; and
an erasing module configured to erase the information stored in the nonvolatile memory after the setting module has completed the operation setting,
the device controller comprising a command issuing module configured to issue a command to the at least one device in order to cause the nonvolatile memory to store operation setting information before either power-off or resetting.

2. The information processing apparatus of claim 1, wherein the device controller further comprises a setup module configured to set whether to issue the command for each of the at least one device before either power-off or resetting.

3. The information processing apparatus of claim 2, wherein the setup module of the device controller is configured to set contents of operation setting information to be stored in the nonvolatile memory for the at least one device.

4. The information processing apparatus of claim 1, wherein the device controller is a basic input/output system (BIOS).

5. A device either incorporated in or connected to the body of an information processing apparatus, the device comprising:
a nonvolatile memory;
a command receiver configured to receive a command to cause the nonvolatile memory to store operation setting information from the body of the information processing apparatus;
a setting module configured to register operation setting based on the information at the time of either power-on or resetting, if the operation setting information has been stored in the nonvolatile memory; and
an erasing module configured to erase the information stored in the nonvolatile memory after the setting module has completed the operation setting.

6. A device setting control method of an information processing apparatus which comprises at least one device, a device controller configured to drive-control of the at least one device, and a nonvolatile memory, the method comprising:
issuing a command to cause the nonvolatile memory to store operation setting information before power-off or resetting by the device control module;
receiving a command to cause the nonvolatile memory to store operation setting information at the at least one device;
registering operation setting based on the information, in the at least one device at the time of power-on or resetting, if the operation setting information has been stored in the nonvolatile memory; and
erasing the information stored in the nonvolatile memory after the completion of the operation setting in the at least one device.
